(19) United States
(12) Patent Application Publication
(10) Pub. No.: US 2017/0212464 A1
(43) Pub. Date: Jul. 27, 2017

(54) SHEET PROCESSING DEVICE AND IMAGE FORMING APPARATUS

(71) Applicant: KYOCERA Document Solutions Inc., Osaka (JP)

(72) Inventors: Yoji Isogai, Osaka (JP); Shinya Aono, Osaka (JP)

(21) Appl. No.: 15/414,409

(22) Filed: Jan. 24, 2017

(30) Foreign Application Priority Data
Jan. 26, 2016 (JP) 2016-012786

(51) Int. Cl. G03G 15/00

(52) U.S. Cl. CPC G03G 15/6582

(57) ABSTRACT

A sheet conveying portion conveys a sheet along a conveyance path by a conveyance amount corresponding to a number of pulses in a pulse signal supplied to the sheet conveying portion. A punching portion makes a punch hole in the sheet. The supplied pulse number counting portion counts the number of pulses supplied to the sheet conveying portion while a predetermined part of the sheet moves from a first position to a second position on the conveyance path. A required pulse number calculating portion calculates the number of pulses required for a punch target position on the sheet to move to a punching position on the conveyance path, based on the counted number of supplied pulses and an interval between the first position and the second position. A conveyance control portion supplies a pulse signal to the sheet conveying portion, based on the calculated required number of pulses.

### INCORPORATION BY REFERENCE

This application is based upon and claims the benefit of priority from the corresponding Japanese Patent Application No. 2016-012786 filed on Jan. 26, 2016, the entire contents of which are incorporated herein by reference.

### BACKGROUND

The present disclosure relates to a sheet processing device configured to make a punch hole in a sheet, and to an image forming apparatus including the sheet processing device.

In a sheet processing device that can make a punch hole in a sheet, in general, the sheet is conveyed by a registration roller that is provided on the upstream side of the punching portion in the sheet conveyance direction. The registration roller is driven by a stepping motor. The conveyance amount of the sheet is proportional to the number of pulses in the pulse signal that is supplied to the stepping motor. It is thus possible to control the position of the sheet with respect to the punching portion by controlling the number of pulses supplied to the stepping motor.

However, in the above-described sheet processing device, when the conveyance amount of the sheet per pulse by the registration roller varies for some reason, it is impossible to control, with high accuracy, the position of the sheet with respect to the punching portion. The reason for the variation of the conveyance amount of the sheet per pulse by the registration roller is, for example, slipping of the sheet with respect to the registration roller, or reduction of a roller diameter of the registration roller due to wear.

It is noted that there is known a post-processing device that is configured to eliminate a variation in the position(s) of the punch hole(s) by causing a pressing member to press a rear end portion of the sheet, wherein the pressing member is provided on the upstream side of the punching portion in the sheet conveyance direction.

### SUMMARY

A sheet processing device according to an aspect of the present disclosure includes a sheet conveying portion, a punching portion, a supplied pulse number counting portion, a required pulse number calculating portion, and a conveyance control portion. The sheet conveying portion conveys a sheet along a conveyance path by a conveyance amount corresponding to a number of pulses included in a pulse signal supplied to the sheet conveying portion. The punching portion makes a punch hole in the sheet. The supplied pulse number counting portion counts a number of supplied pulses which is a number of pulses that are supplied to the sheet conveying portion while a predetermined part of the sheet moves from a first position on the conveyance path to a second position on the conveyance path. The required pulse number calculating portion calculates a required number of pulses which is a number of pulses required for a punch target position on the sheet to move to a punching position on the conveyance path, based on the number of supplied pulses counted by the supplied pulse number counting portion and an interval between the first position and the second position. The conveyance control portion supplies a pulse signal to the sheet conveying portion, based on the required number of pulses calculated by the required pulse number calculating portion.

An image forming apparatus according to another aspect of the present disclosure includes: an image forming portion configured to form an image on the sheet based on image data; and the sheet processing device configured to make a punch hole in the sheet.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing an outer appearance of an image forming apparatus according to embodiments of the present disclosure.

FIG. 2 is a block diagram showing a system configuration of the image forming apparatus according to the embodiments of the present disclosure.

FIG. 3 is a diagram showing a configuration of a post-processing portion of the image forming apparatus according to the embodiments of the present disclosure.

FIG. 4 is a diagram showing a configuration of a post-processing portion of the image forming apparatus according to a first embodiment of the present disclosure.

FIG. 5A is a diagram showing an operation of the post-processing portion of the image forming apparatus according to the first embodiment of the present disclosure.

FIG. 5B is a diagram showing an operation of the post-processing portion of the image forming apparatus according to the first embodiment of the present disclosure.

FIG. 5C is a diagram showing an operation of the post-processing portion of the image forming apparatus according to the first embodiment of the present disclosure.

FIG. 6 is a flowchart showing a punch hole making process executed in the image forming apparatus according to the first embodiment of the present disclosure.

FIG. 7 is a diagram showing an example of a punch target position on a sheet.

FIG. 8 is a diagram showing an operation of a post-processing portion of the image forming apparatus according to a second embodiment of the present disclosure.

FIG. 9 is a diagram showing an operation of a post-processing portion of the image forming apparatus according to a third embodiment of the present disclosure.

FIG. 10A is a diagram showing an operation of a post-processing portion of the image forming apparatus according to a fourth embodiment of the present disclosure.

FIG. 10B is a diagram showing an operation of the post-processing portion of the image forming apparatus according to the fourth embodiment of the present disclosure.

FIG. 10C is a diagram showing an operation of the post-processing portion of the image forming apparatus according to the fourth embodiment of the present disclosure.

FIG. 11 is a flowchart showing a punch hole making process executed in the image forming apparatus according to the fourth embodiment of the present disclosure.

FIG. 12A is a diagram showing details of an operation of the post-processing portion of the image forming apparatus according to the fourth embodiment of the present disclosure.

FIG. 12B is a diagram showing details of an operation of the post-processing portion of the image forming apparatus according to the fourth embodiment of the present disclosure.

FIG. 13 is a diagram showing information used in the image forming apparatus according to a variation of the fourth embodiment of the present disclosure.

### DETAILED DESCRIPTION

The following describes embodiments of the present disclosure with reference to the accompanying drawings for the understanding of the present disclosure. It should be noted that the following embodiments are examples of specific embodiments of the present disclosure and should not limit the technical scope of the present disclosure.

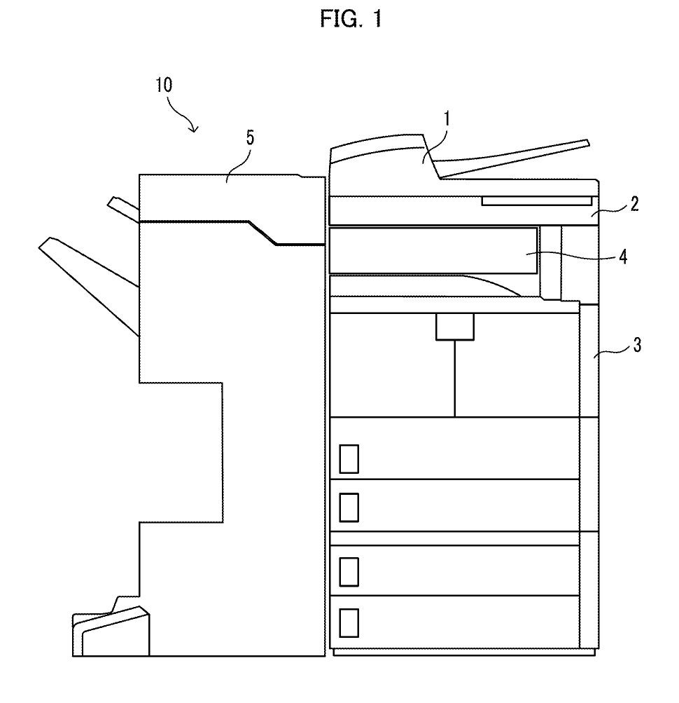

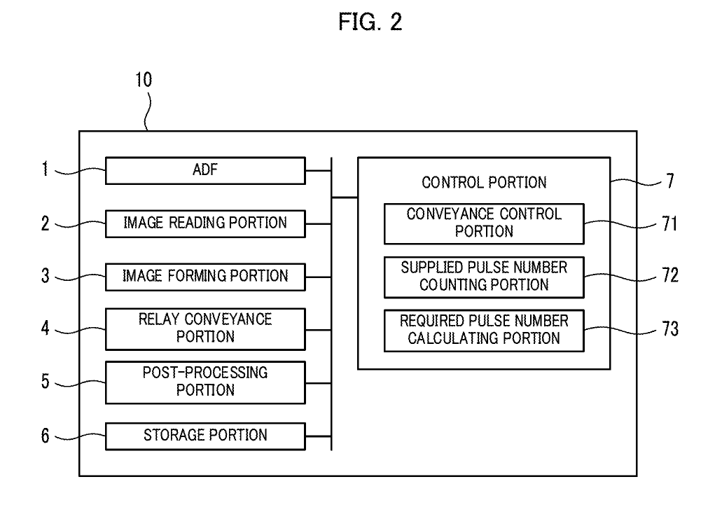

First, an outlined configuration of an image forming apparatus 10 according to the embodiments of the present disclosure is described with reference to FIG. 1 and FIG. 2.

The image forming apparatus 10 is a multifunction peripheral having a plurality of functions such as a scan function for reading image data from a document sheet, a print function for forming an image based on image data, a facsimile function, and a copy function. It is noted that the present disclosure is applicable to image forming apparatuses such as a printer device, a facsimile device, and a copier.

As shown in FIG. 1 and FIG. 2, the image forming apparatus 10 includes an ADF (Auto Document Feeder) 1, an image reading portion 2, an image forming portion 3, a relay conveyance portion 4, a post-processing portion 5, a storage portion 6, and a control portion 7. Here, a device including the post-processing portion 5 and the control portion 7 is an example of the sheet processing device of the present disclosure.

The ADF 1 includes a document sheet setting portion, a plurality of pairs of conveyance rollers, a document sheet pressing, and a sheet discharge portion, and conveys a document sheet so that it is read by the image reading portion 2. The image reading portion 2 includes a document sheet table, a light source, a plurality of mirrors, an optical lens, and a CCD (Charge Coupled Device) that are not shown, and is configured to read image data from a document sheet.

The image forming portion 3 is configured to execute an image forming process (print process) in which to form an image by an electrophotographic system, based on image data that was read by the image reading portion 2. In addition, the image forming portion 3 can execute the print process based on image data input from an external information processing apparatus such as a personal computer. Specifically, the image forming portion 3 includes a photoconductor drum, a charging device, a laser scanning unit, a developing device, a transfer roller, a cleaning device, a fixing device, and a discharge port. It is noted that the image forming portion 3 is not limited to the electrophotographic system, but may form an image by another image forming system such as an ink jet system.

The relay conveyance portion 4 conveys a sheet that has been discharged from the discharge port of the image forming portion 3 to the post-processing portion 5. For example, the relay conveyance portion 4 is an option unit that can be attached to and detached from the discharge portion. It is noted that in the image forming apparatus 10, the discharge portion may be directly connected to the post-processing portion 5 without through the relay conveyance portion 4.

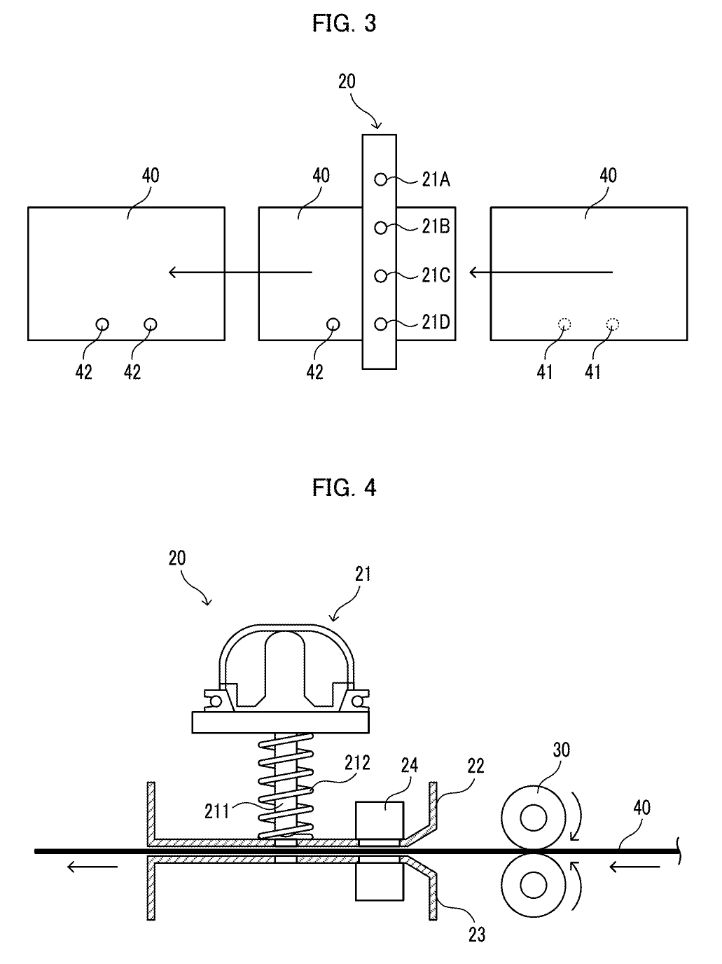

The post-processing portion 5 performs post-processing including a punching process, on sheets with images formed thereon that are conveyed from the relay conveyance portion 4. For example, the post-processing portion 5 is an option unit configured to be connected to the relay conveyance portion 4. The post-processing portion 5 includes a conveyance path, a plurality of pairs of conveyance rollers, a discharge tray, and a punching unit 20 (see FIG. 3) that is described below.

The storage portion 6 is a nonvolatile storage portion such as EEPROM™. In the storage portion 6, various control programs executed by the control portion 7, image data and the like are stored.

The control portion 7 includes control equipment such as CPU, ROM, and RAM. The CPU is a processor that executes various calculation processes. The ROM is a nonvolatile storage portion in which various information such as control programs for causing the CPU to execute various processes such as a punch hole making process described below, are stored in advance. The RAM is a volatile or nonvolatile storage portion that is used as a temporary storage memory (working area) for the various processes executed by the CPU.

Specifically, the control portion 7 includes a conveyance control portion 71, a supplied pulse number counting portion 72, and a required pulse number calculating portion 73. It is noted that the control portion 7 functions as these processing portions when it executes processes in accordance with the control programs. In addition, the control portion 7 may include an electronic circuit that realizes part or all of processing functions of the processing portions.

### First Embodiment

In the following, a description is given of a configuration for executing the punching process in the image forming apparatus according to the first embodiment of the present disclosure, with reference to FIG. 3 and FIG. 4.

As shown in FIG. 3, the punching unit 20 is disposed in the conveyance path of the post-processing portion 5 in which a sheet 40 is conveyed. The punching unit 20 makes punch holes in the sheet 40 conveyed in the conveyance path, at punch target positions 41 on the sheet 40. The punching unit 20 includes four punching portions 21A to 21D that are aligned along a direction (hereinafter referred to as a “width direction”) vertical to a sheet conveyance direction (hereinafter merely referred to as a “conveyance direction”). One or more punching portions 21 among the four punching portions 21A to 21D are selectively activated by a punching motor (not shown) to make a punch hole(s) 42 in the sheet 40. It is noted that the punching unit 20 can be moved in the width direction by a unit movement mechanism (not shown). This makes it possible to make a punch hole(s) 42 at an arbitrary position(s) on the sheet 40 conveyed in the conveyance path. It is noted that the number of punching portions 21 included in the punching unit 20 is not limited to four, but may be, for example, one, or five or more.

FIG. 4 shows a cross section of the punching unit 20 taken along the conveyance direction. The punching unit 20 includes the punching portions 21, a supporting base 22, a common die 23, and a sheet sensor 24. Each punching portion 21 includes a punching blade 211 formed in a cylindrical shape, and a coil spring 212 wound along an outer circumference of the punching blade 211. The supporting base 22 is elongated along the width direction and supports the punching portions 21A to 21D. The supporting base 22 has hole portions for the punching blades 211 to pass therethrough. The common die 23 is elongated along the width direction and supports the supporting base 22 from below. The common die 23 supports the supporting base 22 at opposite end portions in the width direction, and a gap is formed between the supporting base 22 and the common die 23 as a part of the conveyance path. The common die 23 also has hole portions for the punching blades 211 to pass therethrough. When the punching blade 211 is pressed downward by a cam (not shown) against a biasing force of the coil spring 212, the punching blade 211 passes through hole portions formed in the supporting base 22 and the common die 23, thereby the punch hole 42 is made in the sheet 40.

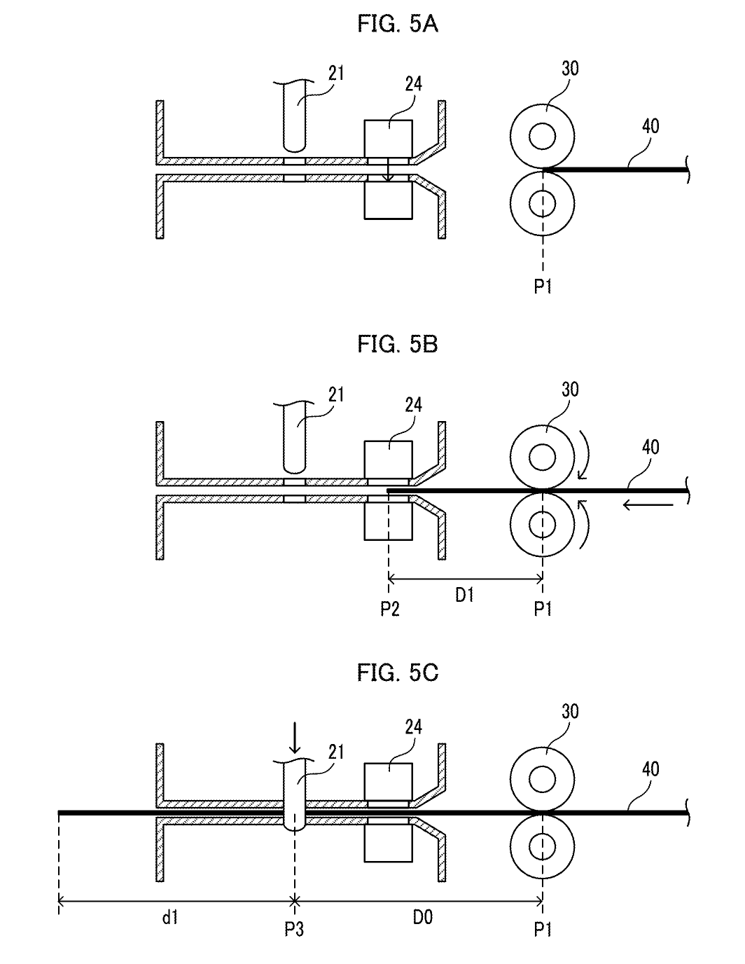

The sheet sensor 24 can detect presence/absence of the sheet 40 at a detection position P2 (see FIG. 5B). For example, the sheet sensor 24 is a transmission-type optical sensor including a light emitting portion and a light receiving portion. For example, when the sheet 40 is absent at the detection position P2, light emitted from the light emitting portion is irradiated to the light receiving portion. On the other hand, when the sheet 40 is present at the detection position P2, light emitted from the light emitting portion is blocked by the sheet 40 and is not irradiated to the light receiving portion. With this configuration, the light receiving portion outputs an electric signal that corresponds to whether the sheet 40 is present or absent at the detection position P2. The electric signal output from the light receiving portion is input to the control portion 7. It is noted that the sheet sensor 24 may be a reflection-type optical sensor, an ultrasonic sensor or the like.

A registration roller 30 is provided in the conveyance path on the upstream side of the punching unit 20 in the sheet conveyance direction (hereinafter merely referred to as “upstream side”). The registration roller 30 is driven by a stepping motor (not shown) to convey the sheet 40 along the conveyance path, by a conveyance amount that corresponds to the number of pulses in a pulse signal supplied to the stepping motor. The registration roller 30 and the stepping motor constitute an example of the sheet conveying portion of the present disclosure.

Next, a description is given of an operation pertaining to the punching process in the image forming apparatus according to the first embodiment of the present disclosure, with reference to FIG. 5A to FIG. 5C.

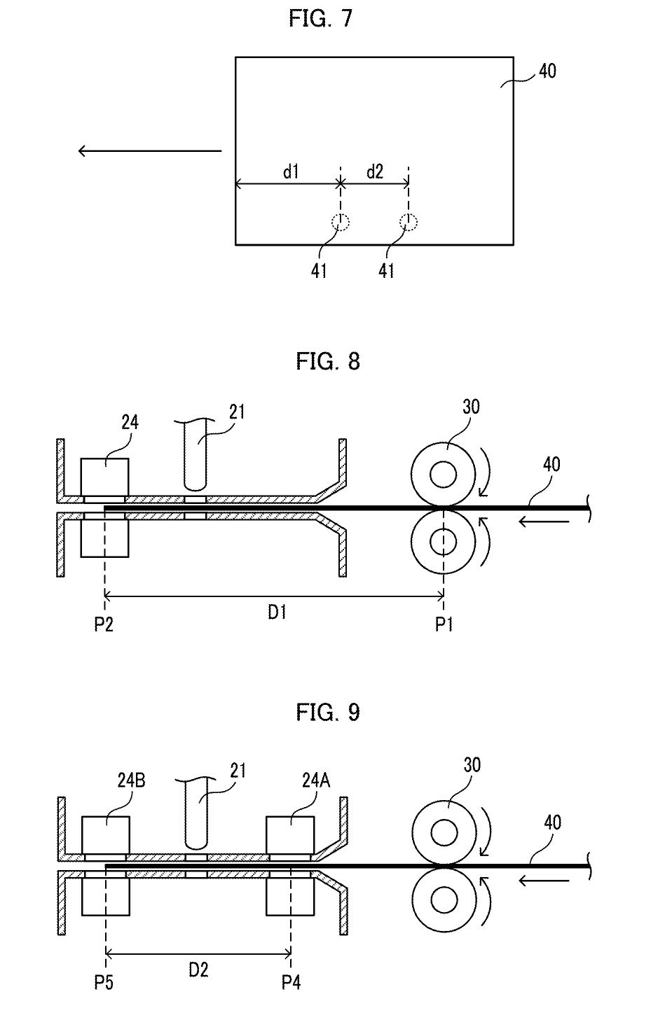

The conveyance control portion 71 controls the registration roller 30 by supplying the pulse signal to the stepping motor. The rotation amount of the registration roller 30 is proportional to the number of pulses in the pulse signal supplied to the stepping motor. As a result, if, in a state shown in FIG. 5A where an end portion of the sheet 40 on the downstream side in the sheet conveyance direction (hereinafter merely referred to as a “sheet front end”) is contacting a nip position P1 of the registration roller 30 that is stopped, a pulse signal having pulses whose number corresponds to a distance d1 (see FIG. 7), is supplied to the stepping motor, the first punch target position 41 on the sheet 40 will move to a punching position P3, wherein the distance d1 is a distance between the sheet front end and the first punch target position 41 on the sheet 40. However, when the conveyance amount of the sheet 40 per pulse by the registration roller 30 varies for some reason, it is impossible to control, with high accuracy, the position of the sheet 40 with respect to the punching portion 21. The reason for the variation of the conveyance amount of the sheet 40 per pulse by the registration roller 30 is, for example, slipping of the sheet 40 with respect to the registration roller 30, or reduction of a roller diameter of the registration roller 30 due to wear. It is noted that there is known a post-processing device that is configured to eliminate a variation in the position(s) of the punch hole(s) by causing a pressing member to press a rear end portion of the sheet, wherein the pressing member is provided on the upstream side of the punching portion in the sheet conveyance direction. However, the above-mentioned post-processing device needs to include the pressing member and a swinging mechanism for swinging the pressing member. This makes the device configuration complicated. In addition, in a case where, for example, two or more punch holes are made in a sheet in sequence along the sheet conveyance direction, the distance to the rear end portion of the sheet greatly varies depending on the punch hole, and thus it is difficult to eliminate the variation in the position(s) of the punch hole(s) by using the pressing member. On the other hand, in the image forming apparatus 10 according to the present embodiment, it is possible to make the punch hole(s) 42 in the sheet 40 at accurate position(s) on the sheet 40 with a simple configuration by the operation described below.

The supplied pulse number counting portion 72 counts the number of pulses supplied to the stepping motor while the sheet front end (an example of the “predetermined part of the sheet” of the present disclosure) moves from the nip position P1 (an example of the first position of the present disclosure) to the detection position P2 (an example of the second position of the present disclosure). That is, the supplied pulse number counting portion 72 counts the number of pulses (supplied pulses) supplied to the stepping motor while the sheet 40 moves from a position shown in FIG. 5A to a position shown in FIG. 5B. The number of supplied pulses may vary reflecting the slipping of the sheet 40 with respect to the registration roller 30, or the reduction in the roller diameter of the registration roller 30 due to wear.

The required pulse number calculating portion 73 calculates the number of pulses (the required number of pulses) that are required to move the punch target position 41 on the sheet 40 to the punching position P3, based on the number of supplied pulses counted by the supplied pulse number counting portion 72, and an interval D1 between the nip position P1 and the detection position P2. For example, the required pulse number calculating portion 73 calculates the conveyance amount of the sheet 40 per pulse in the pulse signal supplied to the registration roller 30, by dividing the interval D1 by the number of supplied pulses. The required pulse number calculating portion 73 then calculates the number of pulses that are required to move the punch target position 41 on the sheet 40 to the punching position P3, based on the conveyance amount of the sheet 40 per pulse.

The conveyance control portion 71 supplies the pulse signal to the stepping motor, based on the required number of pulses calculated by the required pulse number calculating portion 73. This makes it possible to make the punch hole(s) 42 at accurate position(s) on the sheet 40 even if the conveyance amount of the sheet 40 per pulse varies reflecting the slipping of the sheet 40 with respect to the registration roller 30, or the reduction in the roller diameter of the registration roller 30 due to wear. In particular, the required number of pulses is calculated based on the number of pulses (supplied pulses) that are supplied to the stepping motor while the sheet front end moves from the nip position P1 to the detection position P2. Thus, even if each sheet 40 is different in slipperiness, it is possible to make the punch hole(s) 42 in each sheet 40 at accurate position(s) on each sheet 40.

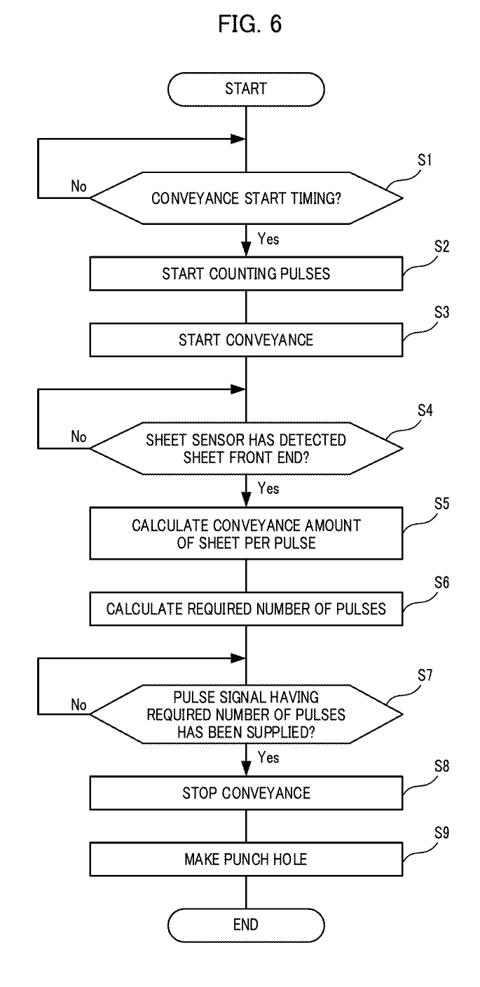

In the following, an example of the procedure of the punch hole making process executed by the control portion 7, is described with reference to FIG. 6. Here, steps S1, S2, . . . represent numbers assigned to the processing procedures (steps) executed by the control portion 7. It is noted that the punch hole making process is executed as a part of the print process when an instruction to execute the print process including the formation of the punch hole(s) 42 is made in the image forming apparatus 10.

<Step S1>

First, in step S1, the control portion 7 determines whether or not a conveyance start timing to cause the registration roller 30 to start conveying a sheet 40, has come. Whether or not a conveyance start timing has come can be determined, for example, based on an elapse time from a detection of a sheet 40 by a sheet sensor (not shown) that is provided on the upstream side of the registration roller 30 (for example, a sheet sensor provided near the discharge port). Specifically, when a predetermined time has elapsed from a detection of a sheet 40 by the sheet sensor that is provided on the upstream side of the registration roller 30, it is estimated that the sheet front end has reached the nip position of the registration roller 30, and it is determined that the conveyance start timing has come. Upon determining that the conveyance start timing has come (S1: Yes, FIG. 5A), the control portion 7 moves the process to step S2. On the other hand, upon determining that the conveyance start timing has not yet come (S1: No), the control portion 7 repeats the process of step S1 until it determines that the conveyance start timing has come.

<Step S2>

In step S2, the control portion 7 starts counting the number of pulses supplied to the stepping motor.

<Step S3>

In step S3, the control portion 7 starts conveying the sheet 40. That is, the control portion 7 starts supplying the pulse signal to the stepping motor.

<Step S4>

In step S4, the control portion 7 determines whether or not the sheet sensor 24 has detected a sheet front end. Upon determining that the sheet sensor 24 has detected a sheet front end (S4: Yes, FIG. 5B), the control portion 7 moves the process to step S5. On the other hand, upon determining that the sheet sensor 24 has not detected a sheet front end (S4: No), the control portion 7 repeats the process of step S4 until the sheet sensor 24 detects a sheet front end.

<Step S5>

In step S5, the control portion 7 calculates the conveyance amount of the sheet 40 per pulse, based on the number of pulses (supplied pulses) supplied to the stepping motor during a period from step S2 to the current point in time, and the interval D1 between the nip position P1 and the detection position P2. Specifically, the control portion 7 calculates the conveyance amount of the sheet 40 per pulse in the pulse signal supplied to the registration roller 30, by dividing the interval D1 by the number of supplied pulses. For example, in a case where the interval D1 is 20 mm and the number of supplied pulses is 205, the conveyance amount of the sheet 40 per pulse is calculated as 0.09756 mm/pulse.

<Step S6>

In step S6, the control portion 7 calculates the required number of pulses based on the conveyance amount of the sheet 40 per pulse calculated in step S5. For example, suppose that D0 denotes the interval between the nip position P1 and the punching position P3 (see FIG. 5C), and d1 denotes the distance from the sheet front end to the punch target position 41 on the sheet 40, then a conveyance amount of sheet 40 required for the punch target position 41 on the sheet 40 (in the state of FIG. 5B) to move to the punching position P3, is represented as (d1+D0−D1). Therefore, the number of pulses required for the punch target position 41 on the sheet 40 to move to the punching position P3 is obtained by dividing (d1+D0−D1) by the conveyance amount of the sheet 40 per pulse calculated in step S5.

<Step S7>

In step S7, the control portion 7 determines whether or not the pulse signal having the required number of pulses calculated in step S6 has been supplied to the stepping motor. Upon determining that the pulse signal having the required number of pulses has been supplied to the stepping motor (S7: Yes), the control portion 7 moves the process to step S8. On the other hand, upon determining that the pulse signal having the required number of pulses has not been supplied to the stepping motor (S7: No), the control portion 7 repeats the process of step S7 until it determines that the pulse signal having the required number of pulses has been supplied to the stepping motor.

<Step S8>

In step S8, the control portion 7 stops the conveyance of the sheet 40. That is, the control portion 7 stops supplying the pulse signal to the stepping motor. As a result, the sheet 40 is stopped in a state where the punch target position 41 on the sheet 40 is positioned at the punching position P3.

<Step S9>

In step S9, the control portion 7 actuates the punching portion(s) 21 and causes it to make the punch hole(s) 42 in the sheet 40 (see FIG. 5C).

It is noted that in a case where two punch holes 42 are made in the sheet 40 in sequence along the sheet conveyance direction, the control portion 7, after step S9, makes a punch hole 42 at the second punch target position 41 on the sheet 40, as well. In this case, the conveyance amount of the sheet 40 required for the second punch target position 41 on the sheet 40 (in the state shown in FIG. 5C) to move to the punching position P3, is an interval d2 (see FIG. 7) between the first and second punch target positions 41 on the sheet 40. As a result, the number of pulses required for the second punch target position 41 on the sheet 40 to move to the punching position P3 can be calculated by dividing the interval d2 by the conveyance amount of the sheet 40 per pulse calculated in step S5. This also applies to a case where three or more punch holes 42 are made in the sheet 40 in sequence along the sheet conveyance direction.

When making the punch holes 42 at the punch target positions 41 is completed, the punch hole making process is ended.

It is noted that the processes of steps S3, S7 and S8 are executed by the conveyance control portion 71 of the control portion 7. The process of step S2 is executed by the supplied pulse number counting portion 72 of the control portion 7. The processes of steps S5 and S6 are executed by the required pulse number calculating portion 73 of the control portion 7.

It is noted that in a case where a plurality of sheets 40 of a same type are conveyed in sequence by the registration roller 30, with regard to the second or succeeding sheet 40, the pulse signal may be supplied to the stepping motor based on the required number of pulses that was calculated in step S6 when the first sheet 40 was conveyed. This is because, when a plurality of sheets 40 of a same type are conveyed in sequence by the registration roller 30, the slipperiness of the sheet 40 and the roller diameter of the registration roller 30 can be regarded as substantially the same for each sheet 40, and thus the conveyance amount of the sheet 40 per pulse is regarded as not substantially varying. Therefore, in such a case, it is possible to prevent shifting of the punch hole(s) 42 among the plurality of sheets 40 by allowing the required number of pulses that was calculated in step S6 when the first sheet 40 was conveyed, to be shared by each and all of the sheets 40.

### Second Embodiment

In the first embodiment described above, the sheet sensor 24 is provided on the upstream side of the punching portions 21. However, the present disclosure is not limited to the configuration. For example, as the second embodiment, as shown in FIG. 8, the sheet sensor 24 may be provided on the downstream side of the punching portions 21.

In a case where the sheet sensor 24 is provided on the downstream side of the punching portions 21, the interval D1 between the nip position P1 and the detection position P2 is greater than in a case where the sheet sensor 24 is provided on the upstream side of the punching portions 21. As a result, in this case, the conveyance amount of the sheet 40 per pulse calculated in step S5 is expected to be more accurate.

When the sheet sensor 24 is provided on the downstream side of the punching portions 21, it is necessary to set the position of the sheet sensor 24 so that the punch target position 41 on the sheet 40 does not reach the punching position P3 before the sheet front end reaches the detection position P2. It is noted that in general, the distance d1 from the sheet front end to the punch target position 41 on the sheet 40 would vary depending on the size of the sheet. It is therefore preferable that the interval between the sheet sensor 24 and the punching portions 21 is equal to or smaller than the possible smallest value of the distance d1.

On the other hand, when the sheet sensor 24 is provided on the upstream side of the punching portions 21 as in the first embodiment, the punch hole(s) 42 can be made at a position(s) very close to the sheet front end.

### Third Embodiment

In the first embodiment described above, the required number of pulses is calculated based on the number of pulses that are supplied to the stepping motor while the sheet front end moves from the nip position P1 to the detection position P2. However, the present disclosure is not limited to the configuration. For example, as the third embodiment, as shown in FIG. 9, two sheet sensors (an upstream-side sheet sensor 24A and a downstream-side sheet sensor 24B) may be provided, the downstream-side sheet sensor 24B being provided on the downstream side of the upstream-side sheet sensor 24A.

In the third embodiment, the required number of pulses is calculated based on the number of pulses (supplied pulses) that are supplied to the stepping motor while the sheet front end moves from a detection position P4 (an example of the first position of the present disclosure) of the upstream-side sheet sensor 24A to a detection position P5 (an example of the second position of the present disclosure) of the downstream-side sheet sensor 24B. For example, the conveyance amount of the sheet 40 per pulse is obtained by dividing an interval D2 between the detection position P4 and the detection position P5 by the number of pulses that are supplied to the stepping motor while the sheet front end moves from the detection position P4 to the detection position P5.

In the first to third embodiments described above, the sheet sensor 24 is provided on the punching unit 20. However, the present disclosure is not limited to the configuration. For example, the sheet sensor 24 may be provided on the upstream side or the downstream side of the punching unit 20. In addition, the sheet sensor 24 may be disposed at an arbitrary position in the width direction as far as it can detect the sheet front end. For example, the sheet sensor 24 may be disposed at a central position in the width direction of the conveyance path.

### Fourth Embodiment

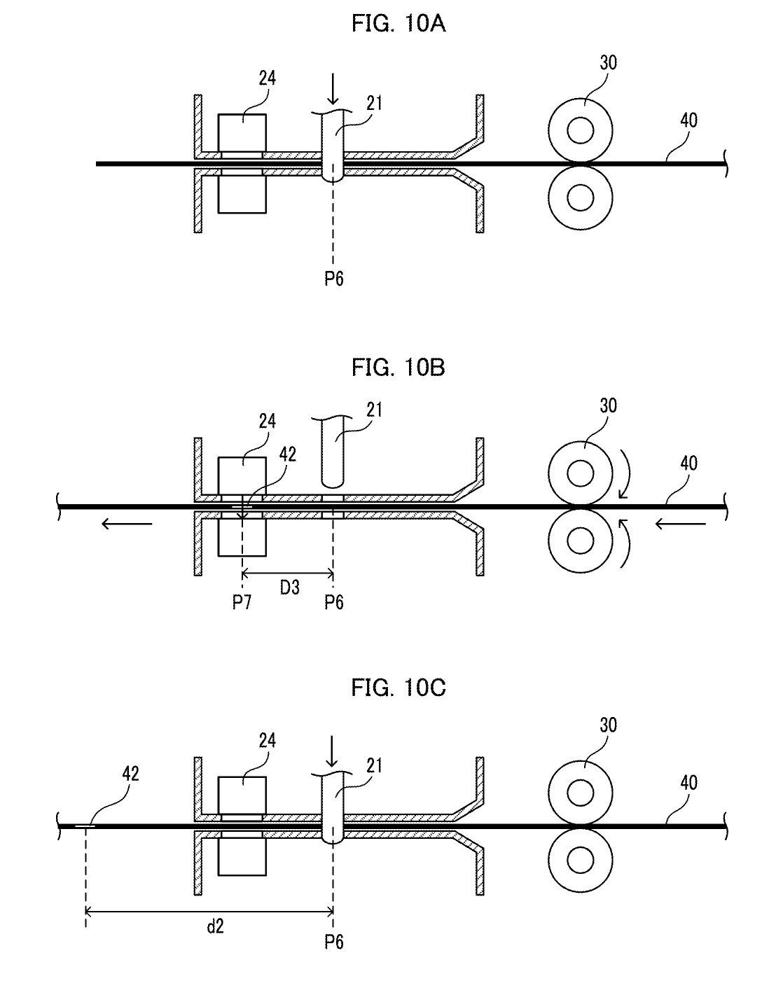

In the first embodiment described above, the sheet sensor 24 is used to detect the sheet front end. However, the present disclosure is not limited to this configuration. For example, as the fourth embodiment, the sheet sensor 24 may detect the punch holes 42 (an example of the “predetermined part of the sheet” of the present disclosure). In the following, with reference to FIG. 10A to FIG. 12B, a description is given of a configuration and operation of the image forming apparatus 10 according to the fourth embodiment of the present disclosure.

In the image forming apparatus 10 of the fourth embodiment, the configuration of the post-processing portion 5 is the same as that in the second embodiment shown in FIG. 8. That is, in the fourth embodiment, as shown in FIG. 10A, the sheet sensor 24 is provided on the downstream side of the punching portions 21.

In the fourth embodiment, a punching portion 21 makes at least two punch holes 42 in the sheet 40 in sequence along the sheet conveyance direction. It is noted that in the following description, with regard to arbitrary two punch holes 42 among a plurality of punch holes 42 that are made in the same sheet 40 along the sheet conveyance direction, a punch hole 42 that is made earlier, namely a punch hole 42 on the downstream side is referred to as a “preceding punch hole 42”, and a punch hole 42 that is made later, namely a punch hole 42 on the upstream side is referred to as a “succeeding punch hole 42”.

In the fourth embodiment, as shown in FIG. 10A, first the preceding punch hole 42 is made in the sheet 40. It is noted that, as a processing method that is performed before the preceding punch hole 42 is made in the sheet 40, an arbitrary processing method can be adopted. For example, as in the second embodiment described above, a punch target position 41 on the sheet 40 that corresponds to the preceding punch hole 42 may be moved to a punching position P6 based on the number of pulses supplied to the stepping motor while the sheet front end moves from the nip position of the registration roller 30 to a detection position P7 (see FIG. 10B) of the sheet sensor 24.

After the preceding punch hole 42 is made in the sheet 40, the supplied pulse number counting portion 72 counts the number of pulses supplied to the stepping motor while the preceding punch hole 42 made in the sheet (an example of the “predetermined part of the sheet” of the present disclosure) moves from the punching position P6 (an example of the first position of the present disclosure) to the detection position P7 (an example of the second position of the present disclosure). That is, the supplied pulse number counting portion 72 counts the number of pulses (supplied pulses) supplied to the stepping motor while the sheet 40 moves from a position shown in FIG. 10A to a position shown in FIG. 10B. The number of supplied pulses may vary reflecting the slipping of the sheet 40 with respect to the registration roller 30, or the reduction in the roller diameter of the registration roller 30 due to wear.

The required pulse number calculating portion 73 calculates the number of pulses (the required number of pulses) that are required to move the punch target position 41 on the sheet 40 that corresponds to the succeeding punch hole 42, to the punching position P6, based on the number of supplied pulses counted by the supplied pulse number counting portion 72, and an interval D3 between the punching position P6 and the detection position P7. For example, the required pulse number calculating portion 73 calculates the conveyance amount of the sheet 40 per pulse in the pulse signal supplied to the registration roller 30, by dividing the interval D3 by the number of supplied pulses. The required pulse number calculating portion 73 then calculates the number of pulses that are required to move the punch target position 41 on the sheet 40 that corresponds to the succeeding punch hole 42, to the punching position P6, based on the conveyance amount of the sheet 40 per pulse.

The conveyance control portion 71 supplies the pulse signal to the stepping motor, based on the required number of pulses calculated by the required pulse number calculating portion 73. This makes it possible to make the succeeding punch hole 42 at an accurate position on the sheet 40 even if the conveyance amount of the sheet 40 per pulse varies reflecting the slipping of the sheet 40 with respect to the registration roller 30, or the reduction in the roller diameter of the registration roller 30 due to wear. In particular, the required number of pulses is calculated based on the number of pulses (supplied pulses) that are supplied to the stepping motor while the preceding punch hole 42 moves from the punching position P6 to the detection position P7. Thus, even if each sheet 40 is different in slipperiness, it is possible to make the punch hole(s) 42 in each sheet 40 at accurate position(s) on each sheet 40.

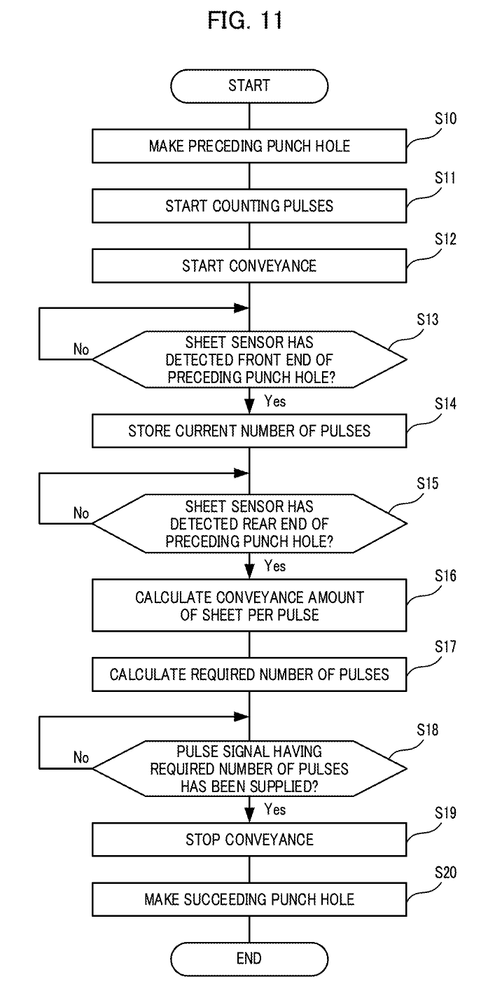

The following describes, with reference to FIG. 11, an example of the procedure of the punch hole making process that is executed by the control portion 7 according to the fourth embodiment. Here, steps S10, S11, . . . represent numbers assigned to the processing procedures (steps) executed by the control portion 7. It is noted that the punch hole making process is executed as a part of the print process when an instruction to execute the print process including the formation of the punch holes 42 is made in the image forming apparatus 10.

<Step S10>

First, in step S10, the control portion 7 controls the registration roller 30 and the punching portion 21 to make the preceding punch hole 42 in the sheet 40 ( see FIG. 10A).

<Step S11>

In step S11, the control portion 7 starts counting the number of pulses supplied to the stepping motor.

<Step S12>

In step S12, the control portion 7 starts conveying the sheet 40. That is, the control portion 7 starts supplying the pulse signal to the stepping motor.

<Step S13>

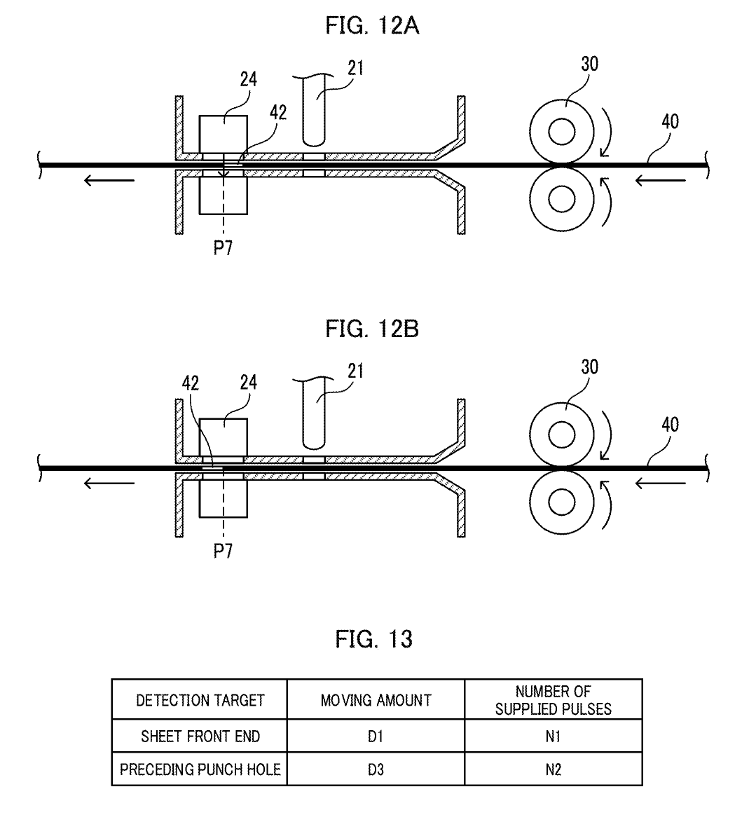

In step S13, the control portion 7 determines whether or not the sheet sensor 24 has detected an end portion of the preceding punch hole 42 on the downstream side in the sheet conveyance direction (hereinafter, merely referred to as a “front end”). Upon determining that the sheet sensor 24 has detected the front end of the preceding punch hole 42 (S13: Yes, FIG. 12A), the control portion 7 moves the process to step S14. On the other hand, upon determining that the sheet sensor 24 has not detected the front end of the preceding punch hole 42 (S13: No), the control portion 7 repeats the process of step S13 until the sheet sensor 24 detects the front end of the preceding punch hole 42.

<Step S14>

In step S14, the control portion 7 temporarily stores, in the RAM or the like, the number of pulses (the first number of pulses) that have been supplied to the stepping motor during a period from step S11 to the current point in time.

<Step S15>

In step S15, the control portion 7 determines whether or not the sheet sensor 24 has detected an end portion of the preceding punch hole 42 on the upstream side in the sheet conveyance direction (hereinafter, merely referred to as a “rear end”). Upon determining that the sheet sensor 24 has detected the rear end of the preceding punch hole 42 (S15: Yes, FIG. 12B), the control portion 7 moves the process to step S16. On the other hand, upon determining that the sheet sensor 24 has not detected the rear end of the preceding punch hole 42 (S15: No), the control portion 7 repeats the process of step S15 until the sheet sensor 24 detects the rear end of the preceding punch hole 42.

<Step S16>

In step S16, the control portion 7 calculates the conveyance amount of the sheet 40 per pulse, based on the first number of pulses stored in step S14, the number of pulses (the second number of pulses) supplied to the stepping motor during a period from step S11 to the current point in time, and the interval D3 between the punching position P6 and the detection position P7. Specifically, the control portion 7 calculates, as the number of supplied pulses, an average value of the first number of pulses and the second number of pulses. The number of supplied pulses corresponds to the number of pulses that are supplied to the stepping motor while the center of the preceding punch hole 42 moves from the punching position P6 to the detection position P7. The control portion 7 calculates the conveyance amount of the sheet 40 per pulse in the pulse signal supplied to the registration roller 30, by dividing the interval D3 by the number of supplied pulses. For example, in a case where the interval D3 is 23 mm, the first number of pulses is 200, and the second number of pulses is 260, the number of supplied pulses is 230 and the conveyance amount of the sheet 40 per pulse is calculated as 0.1 mm/pulse.

<Step S17>

In step S17, the control portion 7 calculates the required number of pulses based on the conveyance amount of the sheet 40 per pulse calculated in step S16. For example, suppose that D3 denotes the interval between the punching position P6 and the detection position P7 (see FIG. 10B), and d2 denotes the distance from the punch target position 41 on the sheet 40 corresponding to the preceding punch hole 42 to the punch target position 41 on the sheet 40 corresponding to the succeeding punch hole 42 (see FIG. 7), then the conveyance amount of the sheet 40 required for the punch target position 41 on the sheet 40 corresponding to the succeeding punch hole 42 (in the state shown in FIG. 10B) to move to the punching position P6 is represented as (d2−D3). Therefore, the number of pulses required for the punch target position 41 on the sheet 40 corresponding to the succeeding punch hole 42, to move to the punching position P6 is obtained by dividing (d2−D3) by the conveyance amount of the sheet 40 per pulse calculated in step S16.

<Step S18>

In step S18, the control portion 7 determines whether or not the pulse signal having the required number of pulses calculated in step S17 has been supplied to the stepping motor. Upon determining that the pulse signal having the required number of pulses has been supplied to the stepping motor (S18: Yes), the control portion 7 moves the process to step S19. On the other hand, upon determining that the pulse signal having the required number of pulses has not been supplied to the stepping motor (S18: No), the control portion 7 repeats the process of step S18 until it determines that the pulse signal having the required number of pulses has been supplied to the stepping motor.

<Step S19>

In step S19, the control portion 7 stops the conveyance of the sheet 40. That is, the control portion 7 stops supplying the pulse signal to the stepping motor.

As a result, the sheet 40 is stopped in a state where the punch target position 41 on the sheet 40 corresponding to the succeeding punch hole 42 is positioned at the punching position P6.

<Step S20>

In step S20, the control portion 7 actuates the punching portion 21 and causes it to make the succeeding punch hole 42 in the sheet 40 (see FIG. 10C).

It is noted that in a case where three or more punch holes 42 are made in a sheet 40 in sequence along the sheet conveyance direction, the processes of steps S10 to S20 are repeated as many times as the number of punch holes 42.

When formation of the punch holes 42 at the punch target positions 41 is completed, the punch hole making process is ended.

It is noted that the processes of steps S12, S18 and S19 are executed by the conveyance control portion 71 of the control portion 7. The process of step S11 is executed by the supplied pulse number counting portion 72 of the control portion 7. The processes of steps S16 and S17 are executed by the required pulse number calculating portion 73 of the control portion 7.

It is noted that in a case where three or more punch holes 42 are made in a sheet 40 in sequence along the sheet conveyance direction by a punching portion 21, the required pulse number calculating portion 73 may calculate the required number of pulses for the third or succeeding punch hole 42 counted from the downstream side in the sheet conveyance direction, based on the number of supplied pulses counted by the supplied pulse number counting portion 72 for the first punch hole 42 counted from the downstream side in the sheet conveyance direction. Specifically, the number of pulses required for the punch target position 41 on the sheet 40 corresponding to the third or succeeding punch hole 42, to move to the punching position P6 may be respectively calculated based on the conveyance amount of the sheet 40 per pulse that was calculated in step S16 when the second punch hole 42 counted from the downstream side in the sheet conveyance direction, was made. This makes it possible to, in a case where multiple punch holes 42 are made at equal intervals in a sheet 40, restrict the intervals between the punch holes 42 from varying.

It is noted that in a case where a plurality of sheets 40 of a same type are conveyed in sequence by the registration roller 30, with regard to the second and succeeding sheets 40, the pulse signal may be supplied to the stepping motor based on the required number of pulses that was calculated in step S17 when the first sheet 40 was conveyed. This is because, when a plurality of sheets 40 of a same type are conveyed in sequence by the registration roller 30, the slipperiness of the sheet 40 and the roller diameter of the registration roller 30 can be regarded as substantially the same for each sheet 40, and the conveyance amount of the sheet 40 per pulse would not essentially vary. Therefore, in such a case, it is possible to prevent a shift of the punch holes 42 among the sheets 40 by allowing the required number of pulses that was calculated in step S17 when the first sheet 40 was conveyed, to be shared by all the sheets 40.

In the fourth embodiment, the sheet sensor 24 is provided on the punching unit 20. However, the present disclosure is not limited to this configuration. For example, the sheet sensor 24 may be provided on the upstream side or the downstream side of the punching unit 20. However, the sheet sensor 24 needs to be disposed at a position in the width direction where it can detect the preceding punch hole 42. That is, the punching portion 21 and the sheet sensor 24 need to be aligned along the sheet conveyance direction. As a result, it is preferable that the sheet sensor 24 is supported so as to be integrally moved with the punching portion 21 in a direction vertical to the sheet conveyance direction. In addition, in a case where, for example, as shown in FIG. 3, a plurality of punching portions 21A to 21D are included in the punching unit 20, the sheet sensor 24 may be individually provided in correspondence with each of all the punching portions 21, or in correspondence with each of a plurality of particular punching portions 21 (for example, the punching portions 21A and 21D).

### Variation of Fourth Embodiment

In the fourth embodiment described above, in step S16, the conveyance amount of the sheet 40 per pulse is calculated based on the number of pulses that are supplied to the stepping motor while the preceding punch hole 42 moves from the punching position P6 to the detection position P7. However, the present disclosure is not limited to the configuration. As a variation of the fourth embodiment, the conveyance amount of the sheet 40 per pulse may be calculated by taking into accounts the number of pulses that are supplied to the stepping motor while the sheet front end moves from the nip position of the registration roller 30 to the detection position P7, in addition to the number of pulses that are supplied to the stepping motor while the preceding punch hole 42 moves from the punching position P6 to the detection position P7.

Suppose that, as shown in FIG. 13, for example, D1 denotes the interval between the nip position and the detection position P7, N1 denotes the number of pulses that are supplied to the stepping motor while the sheet front end moves from the nip position to the detection position P7, D3 denotes the interval between the punching position P6 and the detection position P7, and N2 denotes the number of pulses that are supplied to the stepping motor while the preceding punch hole 42 moves from the punching position P6 to the detection position P7, then the conveyance amount of the sheet 40 per pulse is obtained by dividing (D1+D3) by (N1+N2). As a result, in this case, the conveyance amount of the sheet 40 per pulse calculated in step S16 is expected to be more accurate than that obtained in the fourth embodiment. Accordingly, with the configuration of the present variation of the fourth embodiment, it is possible to make the interval between the preceding punch hole 42 and the succeeding punch hole 42 closer to a target value.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A sheet processing device comprising:
a sheet conveying portion configured to convey a sheet along a conveyance path by a conveyance amount corresponding to a number of pulses included in a pulse signal supplied thereto;
a punching portion configured to make a punch hole in the sheet;
a supplied pulse number counting portion configured to count a number of supplied pulses which is a number of pulses that are supplied to the sheet conveying portion while a predetermined part of the sheet moves from a first position on the conveyance path to a second position on the conveyance path;
a required pulse number calculating portion configured to calculate a required number of pulses which is a number of pulses required for a punch target position on the sheet to move to a punching position on the conveyance path, based on the number of supplied pulses counted by the supplied pulse number counting portion and an interval between the first position and the second position; and
a conveyance control portion configured to supply a pulse signal to the sheet conveying portion, based on the required number of pulses calculated by the required pulse number calculating portion.

2. The sheet processing device according to claim 1 further comprising:
a sheet sensor configured to detect the sheet, wherein
the sheet conveying portion includes a registration roller provided on an upstream side of the punching portion in a sheet conveyance direction,
the predetermined part is a downstream-side end portion of the sheet in the sheet conveyance direction,
the first position is a nip position of the registration roller, and
the second position is a detection position of the sheet sensor.

3. The sheet processing device according to claim 2, wherein
the sheet sensor is provided on an upstream side of the punching portion in the sheet conveyance direction.

4. The sheet processing device according to claim 2, wherein
the sheet sensor is provided on the downstream side of the punching portion in the sheet conveyance direction.

5. The sheet processing device according to claim 1, wherein
in a case where a plurality of sheets of a same type are conveyed in sequence by the sheet conveying portion, the conveyance control portion supplies a pulse signal to the sheet conveying portion for a second and succeeding sheets based on the required number of pulses that was calculated by the required pulse number calculating portion when a first sheet was conveyed.

6. The sheet processing device according to claim 1 further comprising:
an upstream-side sheet sensor configured to detect the sheet; and
a downstream-side sheet sensor configured to detect the sheet, the downstream-side sheet sensor being provided on the downstream side of the upstream-side sheet sensor in the sheet conveyance direction, wherein
the predetermined part is a downstream-side end portion of the sheet in the sheet conveyance direction,
the first position is a detection position of the upstream-side sheet sensor, and
the second position is a detection position of the downstream-side sheet sensor.

7. An image forming apparatus comprising:
an image forming portion configured to form an image on the sheet based on image data; and
the sheet processing device according to claim 1 configured to make a punch hole in the sheet.
